(19) United States
(12) Patent Application Publication
(10) Pub. No.: US 2018/0324093 A1
(43) Pub. Date: Nov. 8, 2018

(54) VALIDATING ROUTING DECISIONS

(71) Applicants: Kedar Namjoshi, Basking Ridge, NJ (US); Chaoqiang Deng, Jersey City, NJ (US)

(72) Inventors: Kedar Namjoshi, Basking Ridge, NJ (US); Chaoqiang Deng, Jersey City, NJ (US)

(21) Appl. No.: 15/588,009

(22) Filed: May 5, 2017

(51) Int. Cl. H04L 12/721; H04L 12/24

(52) U.S. Cl. CPC H04L 45/70; H04L 41/14; H04L 45/28; H04L 41/0866; H04L 41/08; H04L 41/0631

(57) ABSTRACT

The present disclosure generally discloses improvements in computer performance for supporting a routing decision validation capability configured to support validation of routing decisions in a communication system. The routing decision validation capability may be configured to validate routing decisions in a communication system including a communication network and a network operating system that is configured to provide control functions for the communication network. The routing decision validation capability may be configured to validate routing decisions for the communication network before the routing decisions are satisfied within the communication network. The routing decision validation capability may be configured to validate routing decisions for the communication network by receiving a routing intent, determining a routing decision for the routing intent, generating a witness for the routing decision, evaluating the witness for the routing decision, and determining whether the routing decision is valid for the routing intent based on the evaluation of the witness for the routing decision.

### TECHNICAL FIELD

The present disclosure relates generally to communication systems and, more particularly but not exclusively, to validation of routing decisions in communication systems.

### BACKGROUND

In many cases, communication networks are evolving from use of distributed routing protocols to use of centralized route calculation capabilities. For example, software defined networking (SDN) is being deployed in many types of communication networks. While there may be significant benefits to use of centralized route calculation capabilities, such as sophisticated route selection and optimization, there also may be significant challenges to use of centralized route calculation capabilities since errors may cause significant network disruption.

### SUMMARY

The present disclosure generally discloses capabilities for supporting validation of routing decisions in communication systems.

In at least some embodiments, an apparatus is configured to support validation of a routing decision for a communication network. The apparatus includes a processor and a memory where the memory is communicatively connected to the processor. The processor is configured to receive a routing intent indicative of a request for a graph within the communication network. The processor is configured to determine a routing decision for the routing intent based on a network model of the communication network. The processor is configured to generate a witness for the routing decision, wherein the witness comprises a set of one or more sub-graphs in the communication network. The processor is configured to evaluate the witness for the routing decision based on the routing intent and based on the network model of the communication network. The processor is configured to determine, based on evaluation of the witness for the routing decision, whether the routing decision is valid for the routing intent. In at least some embodiments, a non-transitory computer-readable storage medium stores instructions which, when executed by a computer, cause the computer to perform a corresponding method configured to support validation of a routing decision for a communication network. In at least some embodiments, a corresponding method is configured to support validation of a routing decision for a communication network.

In at least some embodiments, an apparatus is configured to support validation of a routing decision for a communication network. The apparatus includes a processor and a memory where the memory is communicatively connected to the processor. The processor is configured to receive a set of intent-witness pairs indicative of a set of routing intents, having respective witnesses associated therewith, associated with respective routing decisions validated for a network based on a network model of the communication network. The processor is configured to receive, based on a route selection process, a set of modified intent-witness pairs comprising ones of the intent-witness pairs for which the respective witness of the respective routing intent has changed to a respective new witness. The processor is configured to update capacity information of the network model, based on the set of intent-witness pairs and the set of modified intent-witness pairs, to provide thereby an updated network model for the communication network. The processor is configured to verify the routing intents of the set of modified intent-witness pairs based on evaluation of the respective new witnesses of the respective routing intents in the set of modified intent-witness pairs based on the updated network model for the communication network. In at least some embodiments, a non-transitory computer-readable storage medium stores instructions which, when executed by a computer, cause the computer to perform a corresponding method configured to support validation of a routing decision for a communication network. In at least some embodiments, a corresponding method is configured to support validation of a routing decision for a communication network.

### BRIEF DESCRIPTION OF THE DRAWINGS

The teachings herein can be readily understood by considering the following detailed description in conjunction with the accompanying drawings, in which:

FIG. 1 depicts an example communication system including a communication network and a network operating system configured to support validation of routing decisions for the communication network;

FIG. 2 depicts examples of routing intents for different routing intent types, witnesses for routing decisions for the routing intent types, and approaches for determining whether the witnesses for the routing decisions satisfy the routing intents for the routing intent types;

FIG. 3 depicts example pseudocode for verifying that witnesses satisfy intents;

FIG. 4 depicts an example of network refinement to abstract a communication network to form an abstracted network for use in validating routing decisions for the communication network;

FIG. 5 depicts an example process for network refinement to abstract a communication network to form an abstracted network for use in validating routing decisions for the communication network;

FIG. 6 depicts an example method for supporting validation of routing decisions for a communication network; and

FIG. 7 depicts a high-level block diagram of a computer suitable for use in performing various functions presented herein.

To facilitate understanding, identical reference numerals have been used, where possible, to designate identical elements that are common to the figures.

### DETAILED DESCRIPTION

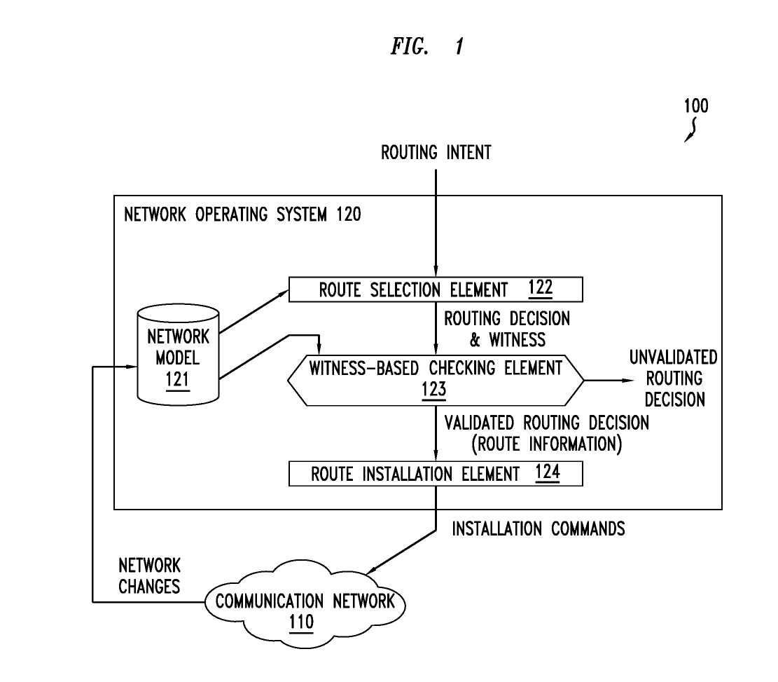

The present disclosure generally discloses improvements in computer performance for supporting a routing decision validation capability configured to support validation of routing decisions in a communication system. The routing decision validation capability may be configured to validate routing decisions in a communication system including a communication network and a network operating system that is configured to provide control functions for the communication network. The routing decision validation capability may be configured to validate routing decisions for the communication network before the routing decisions are satisfied within the communication network. The routing decision validation capability may be configured to validate routing decisions for the communication network, before the routing decisions are satisfied within the communication network, based on witnessing. The routing decision validation capability may be configured to validate routing decisions for the communication network by receiving a routing intent, determining a routing decision for the routing intent, generating a witness for the routing decision, evaluating the witness for the routing decision, determining whether the routing decision is valid for the routing intent based on the evaluation of the witness for the routing decision. The routing decision validation capability may be configured to validate routing decisions in a communication system that is using a logically centralized route calculation capability, such as Software Defined Networking (SDN) or other similar centralized route calculation capabilities. The routing decision validation capability may be configured to validate routing intents for connection-oriented routes. The routing intent validation capability may be configured to validate routing decisions for various routing intent types (e.g., reachability, protection against faults, chains, or the like, as well as various combinations thereof). It will be appreciated that, although primarily presented herein with respect to use of embodiments of the routing decision validation capability to validate routing decisions for specific types of routing intents (namely, end-to-end path-related intents such as paths, protected paths, and chains of paths), embodiments of the routing decision validation capability may be used to validate routing decisions for various other types of routing intents (e.g., broadcast trees, multicast trees, virtual local area networks (VLANs), VLANs with backup paths, or the like). It will be appreciated that these and various other embodiments and potential advantages of the routing decision validation capability may be further understood by way of reference to the example communication system of FIG. 1.

FIG. 1 depicts an example communication system including a communication network and a network operating system configured to support validation of routing decisions for the communication network.

The communication system 100 includes a communication network (CN) 110 and an associated network operating system (NOS) 120 that is configured to provide control functions for the CN 110.

The communication system 100, including CN 110 and NOS 120, may be based on a logically centralized route calculation and installation capability. For example, the centralized route calculation and installation capability may be based on software defined networking (SDN) or any other suitable capability configured to support centralized route calculation. In general, the use of centralized route calculation and installation capabilities, such as SDN, is a radical departure from the use of distributed protocols for route calculation and installation. While there may be significant benefits to use of centralized route calculation and installation capabilities, such as sophisticated route selection and optimization that may be difficult to realize in a distributed manner, there also may be significant challenges to use of centralized route calculation and installation capabilities since the sophistication of the processes increases the likelihood of errors in the implementation and operation of those processes (where such errors may cause significant network disruptions). For example, the errors may result in generated routes that fail to meet the current routing request or, worse still, that disrupt traffic on active routes that previously had been correctly calculated. The NOS 120 is configured to use witnessing to ensure that erroneous routes, which could cause significant network disruption in the CN 110, are not installed in CN 110.

The CN 110 may include any type of communication network that may be configured to support use of routing paths based on centralized route calculation and installation. For example, the CN 110 may be a wireline network (e.g., Internet Protocol (IP) based, optical, or the like), a wireless network (e.g., cellular, satellite, or the like), or the like, as well as various combinations thereof. The CN 110, although omitted for purposes of clarity may include various nodes and links configured to support routes which may be centrally calculated and installed by the NOS 120.

The NOS 120 is a network operating system configured to support validation of routing decisions for the CN 110. The NOS 120 may be configured to support validation of routing decisions for the CN 110 within the context of supporting centralized route calculation and installation for the CN 110.

The NOS 120 may be configured to compute routes for CN 110 and install routes within CN 110 on-the-fly. The NOS 120 may be configured to provide a formal run-time route certification mechanism that evaluates each route, and rejects any wrongly-calculated route, before the route is installed in the CN 110, thereby reducing or even eliminating implementation errors that may produce wrong routes that could cause significant network disruption. The route certification may be done through a strategy called witnessing in which, for each routing decision, a witness (or justification) is provided by the route calculation mechanism for use in validating the routing decision before the routing decision is implemented in the CN 110. The witnesses may be validated against the desired routing intent using a formal network model before any changes are installed on the CN 110. This strategy shifts trust from the complex system software to a simple route checking function, whose functionality can be formally validated. The NOS 120 may be configured to provide the route certification mechanism based on a language that is configured to specify the routing intents (including support for multiple routing intent types), witnesses for each type of routing intent, and the route checking function for validating the routing decisions for the routing intents based on evaluation of the witnesses. The NOS 120 may be configured to validate route modifications against the specified routing intents, thereby supporting error-checking for guarding against software errors in route selection. The NOS 120 may be configured to provide the route certification mechanism based on a notion of refinement between networks, which preserves the realizability of routing intents across abstraction levels and, thus, allows route calculation algorithms to operate effectively on small abstract networks which hide network complexity with the guarantee that the calculated abstract routes are also realizable in the real network.

The NOS 120 may be configured to react (1) to external, explicit requests for routes (referred to as “routing intents”) and (2) implicitly to changes in the real network (referred to as “network events”) such as failure or degradation of nodes or links. In response, the NOS 120 uses route selection algorithms to formulate a new set of routes, which are then configured and installed on CN 110. The NOS 120 may be considered to be a network transformer; it can be viewed as a function that maps a network (e.g., a set of routes) and a request to a modified network; however, this type of architecture leaves little or no room for error: the correctness of the route selection algorithms and their implementations needs to be trusted. The NOS 120 is configured to support use of formal network models and the generation and checking of witnesses (i.e., justifications) for each routing decision. The NOS 120 may be configured such that the route selection algorithm provides a witness for every routing intent, the witness is checked against the formal network model to certify that the new network meets the new routing intent (if any) and that it continues to meet any earlier routing intents, and, based on a determination that this certification check succeeds, the changes are instantiated on the real network (namely, CN 110). It is noted that the certification step shifts trust away from the complex operating software to the much simpler certification checker, which can be formally validated. As such, there is no need to verify the implementation of the routing algorithms or even the witness generation mechanism; if either has a bug which results in a wrong route or an incorrect witness, the error will be detected by the certification checker and the route will not be installed. The installation process may still rely on standardized mechanisms (e.g., NetConf or the like) and is a trusted component.

The NOS 120 may be configured to compute routes for CN 110 and install routes within CN 110 using various functions that significantly increase the robustness and safety of the NOS 120 in computing routes for CN 110 and install routes within CN 110. For example, the NOS 120 may be configured to provide a run-time route certification method which acts as a safety net, preventing wrong routing choices from disrupting the real network. For example, the NOS 120 may be configured to operate based on a language of intents for connection-based networking. For example, the NOS 120 may be configured to define witnesses for routes, and check those witnesses within the context of validating the routes, in linear time. For example, the NOS 120 may be configured to provide a route checking process that naturally handles a variety of routing specifications and dynamic network changes. For example, the NOS may be configured to support improved (e.g., quicker) implementation and testing of new route selection algorithms, with a guarantee that certification makes it impossible or at least nearly impossible to install erroneous routes that may disrupt network operation. For example, the NOS 120 may be configured to provide a route checking process that operates based on refinement between networks, where the refinement between networks preserves satisfaction of intents and refinement notions ensure that solutions computed on abstract networks remain realizable at more concrete levels (which makes it possible to chain route selection algorithms operating at various different levels of granularity). These and various other mechanisms significantly increase the robustness and safety of the NOS 120.

These and various other functions of the NOS 120 may be further understood by considering details of the NOS 120, a discussion of which follows.

The NOS 120 includes a network model 121, a route selection element 122, a witness-based checking element 123, and a route installation element 124.

The network model 121 is configured to maintain network information describing CN 110. The network information of the network model 121 may include element description information describing the elements of the CN 110 (e.g., nodes, links, or the like), network connectivity information describing the connectivity of the CN 110, or the like, as well as various combinations thereof. For example, the element description information may include descriptions of nodes (e.g., locations, configurations (e.g., racks, slots, cards, ports, or the like), capabilities, or the like, as well as various combinations thereof), descriptions of links (e.g., endpoints, link attributes (e.g., bandwidth, delay, or the like), or the like, as well as various combinations thereof. For example, the network connectivity information may include indications of connectivity between ports of nodes via links. The network model 121 may be updated based on various network events associated with the CN 110, which may include routing changes made within the CN 110 (e.g., responsive to routing intents, as discussed further below), events that occur within the CN 110 (e.g., node degradations or failures, link degradations of failures, or the like), or the like, as well as various combinations thereof. It is noted that updating the network model 121 based on such network events ensures that the network model 121 provides a current view of the CN 110 that may be used for validating routing decisions to be satisfied within the CN 110 (as discussed further below). The network model 121, as discussed further below, may be configured to support new forms of network abstraction, including forms of network abstraction that preserve the realizability of intents. In at least some embodiments, the network model 121 may be an improved or expanded version of NetML. The network model 121 may have various other types of information associated therewith.

The route selection element 122 is configured to provide route selection functions in a manner for supporting validation of routing decisions prior to satisfying the routing decisions within the CN 110.

The route selection element 122 is configured to receive a routing intent that is indicative of a routing request associated with CN 110.

The routing intent may be a request for a graph within CN 110. The routing intent may be a request for a connection-based graph within CN 110. The routing intent may be a request for a set of paths including one or more paths. For example, the routing intent may be a request for a single path, a request multiple paths (e.g., a protected path pair including an active path and an associated protection path, a chain of paths, or the like), or the like. The routing intent may specify the source(s) and destination(s) of the path(s) being requested. The routing intent may have one or more constraint parameters associated therewith (e.g., location constraints, bandwidth constraints, delay constraints, or the like, as well as various combinations thereof). The routing intent may have one or more other characteristics or parameters associated therewith (e.g., a time at which the routing intent is to be activated within the CN 110, a length of time for which the routing intent is to be active within the CN 110, or the like). For example, a routing intent may be a request for a path between node A and node B that supports at least 500 Kbps. For example, a routing intent may be a request for a pair of disjoint active and protection paths between node A and node B with a maximum latency of 10 ms. For example, a routing intent may be a request for a chain of paths including a first path from Los Angeles to Dallas and a second path from Dallas to New York. It will be appreciated that various other types of routing intents may be supported (e.g., broadcast trees, multicast trees, VLANs, or the like).

The routing intent may be received from various sources. The routing intent may be received from a device, a system, a user, or the like. For example, in the case of a device or system, the routing intent may be triggered automatically under certain conditions (e.g., based on a schedule, responsive to detection of an event, or the like, as well as various combinations thereof). For example, in the case of a user, the user that specifies the received routing intent may be any suitable type of user. For example, the user that specified the routing intent may be a network technician of the CN 110, who may specify the routing intent using a system that is configured for use by network technicians to specify routing intents for the CN 110 (e.g., via a user interface of a provisioning system or other suitable type of management system). For example, the user that specified the routing intent may be a user of a customer of the CN 110, who may request use of resources of the CN 110 (e.g., via external access to one or more systems of the CN 110 or the like). The routing intent may be received from other suitable sources.

The routing intent may be received under various conditions. The routing intent may be a new routing intent, a pending and unsatisfied routing intent, an active and satisfied routing intent, or the like, as well as various combinations thereof. For example, a new routing intent may be a routing intent that was just received and has not yet been processed, one that was previously received and has not yet been processed, or the like). For example, a pending and unsatisfied routing intent may be a routing intent that was previously received and processed, but that could not be satisfied at that time (in which case the routing intent may be considered to be received since the routing intent may be undergoing a reevaluation responsive to an event, such as an arrival of a new routing intent, an indication of a network event impacting CN 110, or the like). For example, an active and satisfied routing intent may be a routing intent that was previously received and processed such that one or more associated paths were established within the CN 110 for the routing intent, but which may need to be reevaluated in the future to ensure that the (in which case the routing intent may be considered to be received since the routing intent may be undergoing a reevaluation responsive to an event, such as an arrival of a new routing intent, an indication of a network event impacting CN 110, or the like). It will be appreciated that the routing intent may be received under various other conditions.

The route selection element 122 is configured to determine route information associated with selection of routes through the CN 110. The route selection element 122 is configured to run a route selection algorithm that is configured to select routes through the CN 110 in response to various requests (e.g., routing intents) or events (e.g., network events). It is noted that the format of the route information determined by the route selection element 122 may depend on which route selection algorithm is being used by the route selection element 122 (e.g., different route selection algorithms may output the selected route(s) in different formats). For example, the route information for a selected route may include a description of the route through the CN 110 (e.g., the nodes along the route, the links along the route, ports with which the links are associated, or the like), a description of route changes to be made within the CN 110 in order to realize the route (e.g., identification of ports to be activated, identification of links on which bandwidth is to be allocated, or the like), or the like, as well as various combinations thereof.

The route selection element 122 is configured to determine a routing decision for a routing intent. The routing decision for the routing intent is a routing decision by the route selection algorithm for the routing intent. The route selection element 122 is configured to determine the routing decision for the routing intent based on the network model 121. The routing decision for the routing intent may be specified in various forms or formats, which may depend on which route selection algorithm is being used by the route selection element 122. For example, the routing decision for the routing intent may be specified as a description of the routing decision (e.g., a description of a graph for the routing intent, a description(s) of a set of sub-graphs for the routing intent, or the like), as a set of route change information describing route changes for the routing intent, as a set of configuration commands configured to effect route changes for the routing intent, or the like, as well as various combinations thereof. It is noted that, where the routing decision for the routing intent is specified as a description of the routing decision (e.g., a description of a graph for the routing intent, a description(s) of a set of sub-graphs for the routing intent, or the like), the routing decision and the witness for the routing decision may be similar or identical. It is noted that, where the routing decision for the routing intent is specified as something other than a description of the routing decision, the routing decision and the witness for the routing decision will be different. It is noted that the information used to specify the routing decision may be referred to herein as route information of the routing decision. The route selection element 122 provides the routing decision for the routing intent to the witness-based checking element 123 for use in validating the routing decision for the routing intent based on witnessing.

The route selection element 122 is configured to generate a witness for a routing decision that is to be validated. In general, a witness is a set of one or more sub-graphs that satisfies the routing intent and that may be used to validate the routing decision before the routing decision is satisfied within the CN 110. For example, a witness may include a set of one or more paths that satisfies the routing intent and that may be used to validate the routing decision before the routing decision is satisfied within the CN 110. The witness for the routing decision may be generated by a route selection algorithm of the route selection element 122. The witness that is generated for a routing decision may depend on an intent type of the routing intent, where the intent types may include reachability (e.g., setting up a path from A to B), protection against faults (e.g., setting up disjoint primary and backup paths), chains (e.g., chains of paths through middleboxes, administrative boundaries, or the like), a tree (e.g., a broadcast tree, a multicast tree, or the like), a virtual service (e.g., a VLAN, a VLAN with backup paths, or the like) or the like, as well as various combinations thereof. For example, when the routing intent is a request for a basic segment within CN 110 (e.g., for reachability), the witness may be a single path within the CN 110 for the basic segment of the routing intent. For example, when the routing intent is a request for a protected segment within CN 110 (e.g., for protection against faults), the witness may be a pair of disjoint paths within the CN 110 for the protected segment of the routing intent. For example, when the routing intent is a request for a chain of segments within CN 110 (e.g., for a chain of paths), the witness may be a chain of paths within the CN 110 for the protected segment of the routing intent. The route selection element 122 provides the witness for the routing intent to the witness-based checking element 123 for use in evaluating the witness for validating the routing decision.

The witness-based checking element 123 is configured to perform a witness-based validation of the routing decision for the routing intent.

The witness-based checking element 123 is configured to receive the routing decision for the routing intent and the witness for the routing decision from the route selection element 122 and to evaluate the witness for the routing decision for use in determining whether the routing decision is valid for the routing intent.

The witness-based checking element 123 may be configured to evaluate the witness for the routing decision, for use in determine whether the routing decision is valid for the routing intent, based on at least one of the routing intent and the network model 121.

The evaluation of the witness for the routing intent, where the routing decision includes a description of a set of one or more sub-graphs in the CN 110 (e.g., uses a format similar to that of the witness for the routing decision), may include determining whether the witness for the routing decision satisfies the routing intent. The determination as to whether the witness for the routing decision satisfies the routing intent may include determining, for each of the one or more sub-graphs of the witness based on the routing intent, whether the respective sub-graph satisfies the routing intent.

The evaluation of the witness for the routing intent, where the routing decision does not include a description of a set of one or more sub-graphs in the communication network (but, rather, includes other information such as a description of a set of route changes in CN 110, a set of configuration commands configured to effect a set of route changes in CN 110, or the like), may include determining whether the witness for the routing decision satisfies the routing intent and determining whether the routing decision is consistent with the witness for the routing decision. The determination as to whether the witness for the routing decision satisfies the routing intent may include determining, for each of the one or more sub-graphs of the witness based on the routing intent, whether the respective sub-graph satisfies the routing intent. The determination as to whether the routing decision is consistent with the witness for the routing decision may include determining whether the description of the set of route changes of the routing decision is consistent with the set of one or more sub-graphs of the witness for the routing decision.

The evaluation of the witness for the routing intent may include (1) determining, for each of the one or more sub-graphs of the witness based on the network model 121, whether the respective sub-graph is a valid sub-graph within the CN 110 and (2) determining, for each of the one or more sub-graphs of the witness based on the routing intent, whether the respective sub-graph satisfies the routing intent. For example, the evaluation of the witness for the routing intent may include (1) a determination, for each of the one or more paths of the witness based on the network model 121, whether the respective path is a valid path within the CN 110 and (2) a determination, for each of the one or more paths of the witness based on the routing intent, whether the respective path satisfies the routing intent. The evaluation of the witness that is generated for a routing intent may depend on an intent type of the routing intent. For example, when the routing intent includes a request for a basic segment within the CN 110 and the witness for the routing intent is a single path, evaluation of the witness for the routing intent may include determining, for the single path of the witness, whether the single path satisfies constraints of the routing intent (e.g., region constraints, attribute constraints, or the like, as well as various combinations thereof). For example, when the routing intent includes a request for a protected segment within the CN 110 and the witness for the routing intent is a pair of paths, evaluation of the witness for the routing intent may include determining, for the pair of paths of the witness, whether the paths are disjoint (e.g., node disjoint, node and port disjoint, or the like, as well as various combinations thereof). For example, when the routing intent includes a request for a chain of segments within the CN 110 and the witness for the routing intent is a chain of paths, evaluation of the witness for the routing intent may include determining, for the chain of paths of the witness, whether the chain of paths satisfies an end-to-end constraint (e.g., a delay constraint, a bandwidth constraint, a global region constrain, or the like, as well as various combinations thereof). The determination as to whether the chain of paths satisfies an end-to-end constraint may be performed in a direction from the end of the chain of paths toward the beginning of the chain of paths. The determination as to whether the chain of paths satisfies an end-to-end constraint may be performed by, at a current path of the chain of paths, strengthening a delay requirement on a remaining path of the chain of paths by subtracting a maximum delay incurred on the current path of the chain of paths. The witness-based checking element 123, based on a determination that the two determinations discussed above are successful (and potentially pending validation of route change information when present, a discussed below), determines that the routing intent is validated (and, thus, that the routing intent may be satisfied within CN 110 by the route installation element 124). The witness-based checking element 123, based on a determination that either or both of the determinations that are discussed above are unsuccessful (even where the validation of route change information, as discussed below, may have been successful), determines that the routing intent is not validated (and, thus, that the routing intent is not to be satisfied within CN 110 by the route installation element 124).

The evaluation of the witness for the routing intent may include determining whether the witness for the routing decision satisfies the routing intent. The routing intent may have a property associated therewith. The determination as to whether the witness for the routing decision satisfies the routing intent may include determining, for each of the one or more sub-graphs of the witness based on the network model 121 of the CN 110, whether the respective sub-graph satisfies the property of the routing intent. The property of the routing intent may be configured to describe, for each of the one or more sub-graphs of the witness, a respective shape of the respective sub-graph of the witness and a manner in which the one or more sub-graphs of the witness are related. It is noted that, for at least one of the one or more sub-graphs of the witness, the respective shape of the respective sub-graph of the witness may be a segment, a chain, a cycle, or a tree.

The witness-based checking element 123, based on a determination that the routing decision is valid for the routing intent, prevents installation of the routing decision for the routing intent in the CN 110. The witness-based checking element 123, rather than providing the route information of the unvalidated routing decision to the route installation element 124, may handle the unvalidated routing decision in various other ways, such as by storing unvalidated routing decision information for the unvalidated routing decision (e.g., the routing intent, the routing decision, information associated with the processing performed to try to validate the routing decision, or the like, as well as various combinations thereof), sending unvalidated routing decision information for the unvalidated routing decision to one or more other systems (e.g., for storage, additional analysis, exception handling, or the like), or the like, as well as various combinations thereof.

The witness-based checking element 123, based on a determination that the routing decision is valid for the routing intent, triggers installation of the routing decision for the routing intent in the CN 110. The witness-based checking element 123 may trigger installation of the route decision for the routing intent in the CN 110 by providing the route information of the routing decision for the routing intent to the route installation element 124.

The route installation element 124 is configured to receive the route information for the validated routing decision from the witness-based checking element 123 and to configure the CN 110 to support the validated routing decision. The route installation element 124 generates route installation instructions for the validated routing decision based on the route information for the validated routing decision and provides the route installation instructions to the CN 110 to configure the CN 110 to support the validated routing decision. The route installation instructions may be generated for and provided to nodes of the route(s) of the validated routing decision. For example, the route installation instructions may include instructions for configuring ports of nodes to support traffic, configuring nodes to allocate bandwidth to links connected to the nodes, or the like, as well as various combinations thereof.

The NOS 120 may be configured to provide various other functions supporting the routing decision validation capability for supporting validation of routing decisions in the CN 110.

It will be appreciated that the operation of the NOS 120 in performing routing decision validation processing for CN 110 (and, more specifically, in performing validation of the witness for the routing intent for determining whether the associated routing decision is valid for the routing intent) may be further understood by considering definitions of a formal network model, the intent language, and intent satisfaction, each of which are discussed further below.

A network is defined by a vector of graphs, say (G₀, G₁, . . . Gₙ) for n≥0. As defined below, a graph G₁ is either a primitive graph with a single node, or a non-primitive graph where each node is a reference to a copy of a graph Gⱼ, where j<i, giving the entire network a hierarchical structure. The graph Gₙ is the root of the hierarchy.

A network attribute is a quantity such as bandwidth, bit error rate (BER), cost, delay, or the like, which takes values from the appropriate domain. An attribute vector is a map from the set of attributes to their domains. For example, an example of an attribute vector may be: “(bandwidth=1.0, BER=1.0E-5, cost=20, delay=2.5)”. For simplicity, the present disclosure primarily focuses on two relatively important attributes: bandwidth and delay. The associated attribute vector is written as (bandwidth, delay). Attribute vectors are ordered by a partial relation, [symbol] (read as “better than”), defined appropriately. For bandwidth and delay, the relation (b,d) [symbol] (b′,d′) is defined as (b≥b′) A (d≤d′); i.e., (b, d) is better than (b′,d′) if b represents more bandwidth than b′, and d represents a smaller delay than d′. The inverse relation, [symbol] , is read as “worse than”.

A primitive graph has only one node whose ports are all external. It represents an atomic building block of the network. There can be zero or more links between each pair of ports. Each link may be associated with a capability, which is an attribute vector. The implicit understanding is that all links in a primitive graph represent independent connections. The capability of the i′th link from port p to port q of node n (if defined) is denoted as cap(n, p, q, i). Examples of primitive graphs are channels, multiplexer and demultiplexer elements, adapters, or the like. A channel is a primitive graph with one input port and one output port. A multiplexer has one output port, say q, and multiple input ports; a link is defined only for pairs (x, q), where x≠q. A demultiplexer has one input port, say p, and multiple output ports; a link is defined only for pairs (p, x), where p≠x. These are examples of the more general class of adapters, which transfer traffic between multiple input and output ports.

A non-primitive graph, G1, has internal structure that is given by a pair (N,C), where N is a set of nodes, and C is a set of connections. Every node has an associated set of ports. A connection is a pair of the form ((n, p),(n′, p′)), indicating that port p of node n is to be identified with port p′ of node n′. The external ports of a graph are those ports that are not part of any connection. Every node of Gᵢ contains a reference to a graph Gⱼ, where j<i, along with an isomorphism between the ports of the node and the external ports of Gⱼ. Nodes can be labeled as being in certain “regions”. This may be important for routing constraints that require paths to stay within a certain region.

A hierarchical network can be “flattened” by starting from Gₙ and recursively expanding each node into a copy of the graph to which it refers, if that graph is non-primitive. In the flattened graph, which may be exponentially larger than the network description, nodes refer only to primitive graphs. The satisfaction of intents is defined over the flattened graph of a hierarchical network. In the following, the graph is assumed to be in flattened form. For convenience, the links of a node refer to the links of the primitive graph to which is refers.

A path between port p of node n and port q of node m may be a sequence of “weighted” connected links which may be represented as follows: (p′₀,n₀,l₀,w₀,p₁),(p′₁,n₁,l₁,w₁,p₂), . . . , (p′ₖ,nₖ,lₖ,wₖ,pₖ₊₁), where k≥0, (p′₀,n₀)=(p,n,), and (nₖ,pₖ₊₁)=(m,q). Here, (p′ᵢnᵢ,lᵢ,wᵢ,pᵢ₊₁) represents the lᵢ′th link connecting ports p′ᵢ and pᵢ₊₁ on node nᵢ, with an attribute weight vector wᵢ. In general, a path should meet the following conditions: (a) p′ᵢ and p′ᵢ₊₁ are ports of nᵢ for all i, and is a valid link between those ports, (b) wᵢ represents an allocation that is worse than the capability of its link, i.e., w₁ [symbol] cap (nᵢp′ᵢ,pᵢ₊₁,lᵢ) for all i (which means that wᵢ allocates less bandwidth and assumes a higher delay than the actual capability of the link), and (c) for all i such that i<k, the pair ((nᵢ,pᵢ₊₁),(nᵢ₊₁,p′ᵢ₊₁)) is a connection.

The allocated weight of a path π is defined to be an attribute vector (b, d) such that b is the least bandwidth entry and d is the sum of all the delay entries in the set of weights {wᵢ}. The capability of π is defined as the attribute vector (b′,d′) such that b′ is the least bandwidth entry and d′ is the sum of all the delay entries in the set of capabilities {cap(nᵢ,p′ᵢ,pᵢ_{_}₁,lᵢ)}. It is noted that requirement (b) discussed above ensures that the capability of a path is better than its allocated weight.

As discussed herein, an intent may specify some form of connectivity within the network. For example, an intent may specify a path or set of paths to be established within the network. An intent may be specified in terms of a connectivity between ports, potentially with one or more additional constraints.

For example, the additional constraints may include one or more of a region constraint (e.g., a constraint to either stay within a particular region or avoid a particular region), a minimum bandwidth, a maximum delay, or the like, as well as various combinations thereof. As discussed herein, various types of intents may be supported. The following three types of intents are considered in additional detail below:
(1) Basic Segment: A basic segment specifies a connection between port p of node n and port q of node m, optionally with constraints on attributes and regions.
(2) Protected Segment: A protected segment specifies a connection between port p of node n and port q of node m that has a degree of failure protection. The protection is defined as a set of basic segments between (n, p) and (m, q). For simplicity, it is assumed that there are only two such segments, one referred to as the primary, and the other as the backup. This is commonly referred to as 1+1 protection. Each basic segment has its own constraints on attributes and region.
(3) Chain: A chain is specified as a sequence of segments where the end point of each segment in the chain is connected to the start point of its successor segment (if any). Each segment in the chain may be constrained independently, i.e., some may be protected, while others are basic. A chain may also have end-to-end constraints (i.e., between its endpoints), and global region constraints. Chains may be used to represent paths that must pass through a series of so-called “middle-boxes” in the network where packet processing occurs.

In order to define satisfaction of an intent, a definition of whether a path satisfies a set of attribute and region constraints may need to be provided. Consider a path π=(p′₀,n₀,l₀,w₀,p₁),(p′,n₁,l₁,w₁,p₂), . . . (p′ₖ,nₖ,lₖ,wₖ,pₖ₊₁).

Further consider the following definitions:
(1) Bandwidth: Path π satisfies a minimum bandwidth B if the bandwidth entry in each of the weights {wᵢ} is at least B.
(2) Delay: Path π satisfies a maximum delay D if the sum of all the delay entries in the set of weights {wᵢ} is at most D.
(3) Region: Path π (a) satisfies an avoids (R) constraint, for region R, if none of the nodes on the path is labeled with R and (b) satisfies a within (R) constraint if all of the nodes on the path are labeled with R.

Based on the foregoing definitions, the satisfaction of an intent may be defined as follows for the three intent types as follows:
(1) Basic Segment: A basic segment between port p of node n and port q of node m is satisfied if there exists a path π from (n, p) to (m, q) such that π satisfies all the attribute and region constraints for the segment.
(2) Protected Segment: A protected segment between (n, p) and (m,q) with two basic segments x₀, x₁ is satisfied if there are two paths, π₀, π1 from (n, p) to (m, q) such that for each i, path πᵢ satisfies the requirements of the segment xᵢ and, moreover, π₀ and π₁ have no node-port combination in common except the two end points. I.e., the paths are node and port disjoint. Operationally, this implies that a single node or port failure cannot affect both paths, unless it is at the originating or terminating end.
(3) Chain: A chain from port p of node n to port q of node m is satisfied if there exist path(s) associated with each segment of the chain such that (i) the constraints for each segment are satisfied by its associated path(s), (ii) the end point (i.e., (node, port)) of the path witnessing a segment has a connection to the start point of the path witnessing the next segment, and (iii) the end-to-end constraints and global region constraints for the chain are satisfied on all end-to-end paths that can be constructed from the paths for the segments.

In order to determine whether an intent is satisfied, a witness may be evaluated. For each satisfied intent, there is a set of paths (including one or more paths) that explain why the intent is satisfied. That set of paths is called the witness for that intent. The route computation algorithm is configured to produce an entire set of witnesses, one for each active and new intent, even though the algorithm may be responding to a single new intent or to a single network event. This is because the paths that need to be configured to satisfy the current intent may overlap (and, thus, interfere) with paths configured earlier for other intents. Moreover, as explained below in the discussion on joint satisfaction, the routing algorithm may, in fact, have to reroute witness paths in order to jointly satisfy the new intent along with the previous ones. It is noted that the modifications needed in order to generate witnesses is not described further here as this is specific to the working of the route selection algorithm.

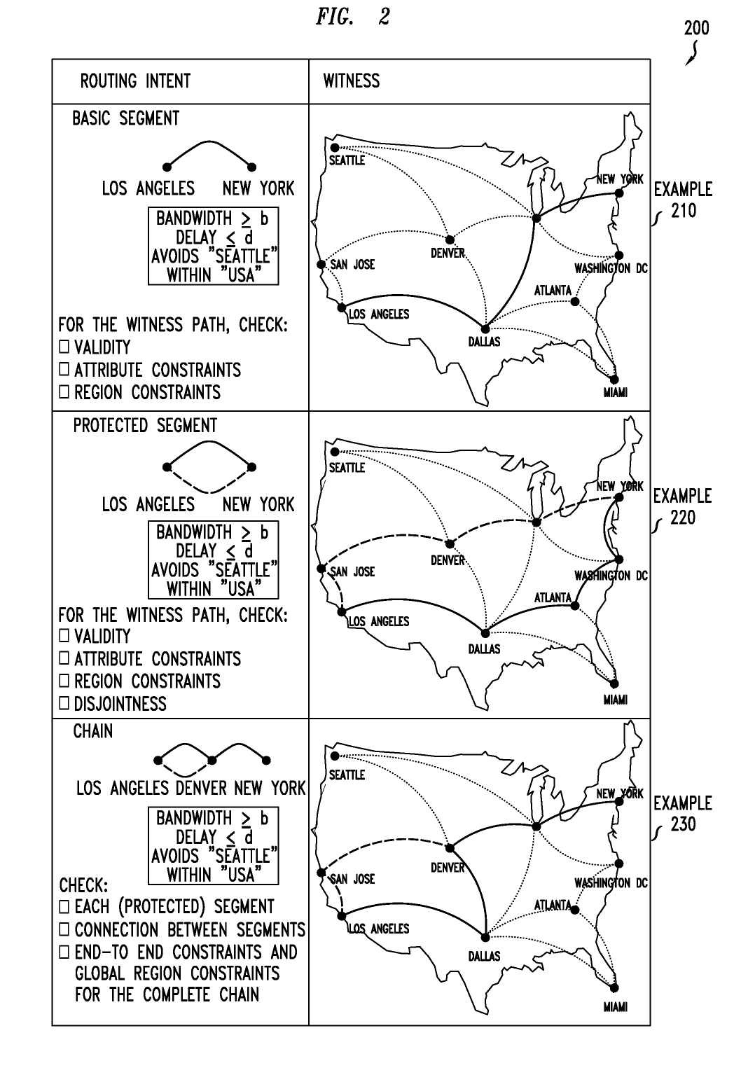

FIG. 2 depicts examples of routing intents for different routing intent types, witnesses for routing decisions for the routing intent types, and approaches for determining whether the witnesses for the routing decisions satisfy the routing intents for the routing intent types.

The example 210 is an example of a basic segment. The routing intent is an intent for a basic segment between Los Angeles and New York. The routing intent also specifies attribute constraints of bandwidth b and delay d and region constraints indicating that the routing intent remain within the US while avoiding Seattle. The witness for the routing intent, as illustrated in FIG. 2, is a path from Los Angeles to New York that traverses links from Los Angeles to Dallas, Dallas to Chicago, and Chicago to New York. The evaluation of the witness includes checking the validity of the witness, checking that the attribute constraints are satisfied, and checking that the region constraints are satisfied.

The example 220 is an example of a protected segment. The routing intent is an intent for a protected segment between Los Angeles and New York. The routing intent also specifies attribute constraints of bandwidth b and delay d and region constraints indicating that the routing intent remain within the US while avoiding Seattle. The witness for the routing intent, as illustrated in FIG. 2, is a set of disjoint paths including (1) a first path from Los Angeles to New York that traverses links from Los Angeles to Dallas, Dallas to Atlanta, Atlanta to Washington D.C., and Washington D.C. to New York and (2) a second path from Los Angeles to New York that traverses links from Los Angeles to San Jose, San Jose to Denver, Denver to Chicago, and Chicago to New York. The evaluation of the witness includes checking the validity of the witness, checking that the attribute constraints are satisfied on each of the paths of the witness, checking that the region constraints are satisfied on each of the paths of the witness, and checking the disjointness of the paths of the witness.

The example 230 is an example of a chain. The routing intent is an intent for a chain between Los Angeles and New York that includes a protected segment between Los Angeles and Denver and a basic segment between Denver and New York. The routing intent also specifies attribute constraints of bandwidth ≥b and delay ≤d and region constraints indicating that the routing intent remain within the US while avoiding Seattle. The witness for the routing intent, as illustrated in FIG. 2, is a set of paths including (1) a protected segment including a pair of disjoint paths between Los Angeles and Denver (including (a) a first path from Los Angeles to Denver that traverses links from Los Angeles to Dallas and Dallas to Denver and (b) a second path from Los Angeles to Denver that traverses links from Los Angeles to San Jose and San Jose to Denver) and (2) a basic segment including a path from Denver to New York that traverses links from Denver to Chicago, and Chicago to New York. The evaluation of the witness includes checking the validity of the witness, checking the pair of disjoint paths between Los Angeles and Denver as would be done for checking a witness for a protected segment (e.g., as discussed with respect to the example 220), checking the basic segment from Denver to New York as would be done for checking a witness for a basic segment (e.g., as discussed with respect to the example 210), checking the connection between the segments, and checking end-to-end attribute constraints and global regional constraints for the complete chain.

In general, a collection of intents is jointly satisfied if there are witnesses for each intent such that the witness paths together do not oversubscribe the bandwidth on any common link. This is defined precisely as follows. Consider the i′th link between ports p, q of node n. Let W be the multi-set of weight vectors w such that each occurrence of w corresponds to a contiguous sub-sequence p, n, i, w, q on some witness path. Then, the sum of the bandwidth entries in W must be at most the bandwidth entry in the capability cap (n, p, q, i). This property should hold over all choices for i, p, q, and n.

Given a set of intents, it is expected that, if all of the intents can be jointly satisfied, then each individual intent can be satisfied. However, the converse is not necessarily true. A trivial counter-example is the case where the graph consists of a single channel, with a single link of bandwidth 2. It is possible to satisfy an intent with min. bandwidth 1, and another with min. bandwidth 1.5 individually for the channel, but joint satisfaction is not possible, as the required total bandwidth for the link is then at least 2.5.

There are various sources of complexity in intent satisfaction. The inability to decompose the satisfaction of intents is one reason why algorithms which aim to allocate resources in an optimal manner have high complexity. For instance, consider a graph where all bandwidth entries are 1. Two intents, each requiring a basic segment between the same endpoints with bandwidth at least 1 can be satisfied jointly if, and only if, there are disjoint paths between the two endpoints; it is NP-complete to find such paths on directed graphs. Another source of complexity is that, in a real system, intents must be satisfied in an on-line fashion, which may lead to sub-optimal choices relative to the (hypothetical) off-line problem where all intents are considered together. A simple example of this is given by a graph with two disjoint paths between its external ports, say σ and δ, the first with bandwidth 1, the other with bandwidth 2. Say that the initial request is for bandwidth 1 and is assigned to δ. The next request is for bandwidth 2. This cannot be satisfied in the current network, as each path now has only one unit of bandwidth available. However, re-routing the first request to σ frees up bandwidth on b to satisfy the second. As this example illustrates, witness paths for intents need not be fixed, they can change as new requests enter the system and the network optimization algorithm shuffles paths in order to satisfy all intents.

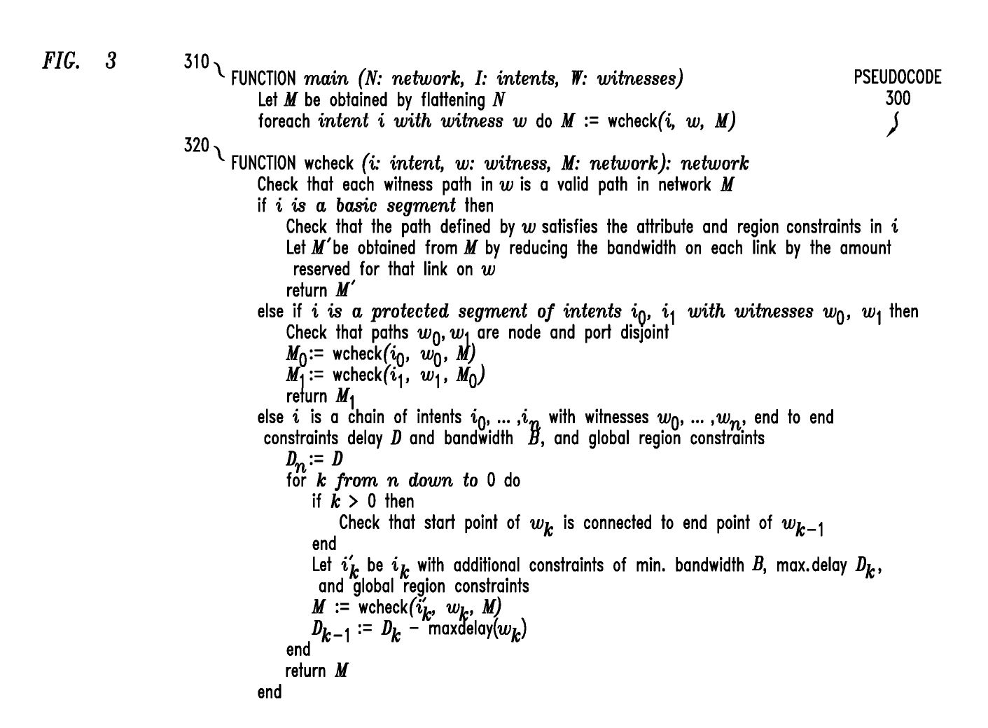

FIG. 3 depicts example pseudocode for verifying that witnesses satisfy intents.

The witness verification pseudocode 300 (which also may be referred to herein as a witness verification process), as discussed further below, works through the list of intents and the provided witnesses, checking that the witness paths corresponding to an intent are (a) valid paths in the network and (b) suffice to satisfy the intent requirements. In order to correctly check intents that place requirements on bandwidth, a map of residual capacity in the network is maintained by removing bandwidth that has been reserved by the witness paths for an intent. For an end-to-end delay constraint on a chain, one operates from the end of the chain, successively strengthening the delay requirement on the remaining prefix of the chain by subtracting the maximum delay incurred on the witness for the current segment of the chain. This is done in the algorithm by adding those constraints to the specified iₖ to obtain the stronger i′ₖ, as shown. If any of the checks fail, the procedure halts and signals an error.

The witness verification pseudocode 300 includes a main function 310 and a witness checking function 320.

The main function 310 is configured to control verification of a set of witnesses for a set of intents. The main function 310 takes as input the network (N), the set of intents (I), and the set of witnesses (W) to be verified for the set of intents (I). The main function 310 obtains an abstract network (M) which is an abstraction of the network (N) and, for each intent (i) and its associated witness (w), calls the witness checking function 320 for evaluating the witness w to determine whether the witness (w) satisfies the intent i (e.g., whether the witness w matches the intent i).

The witness checking function 320 is configured to, for a given intent, evaluate the witness for the intent to determine whether the witness satisfies the intent. The witness checking function 320 is called by the main function 310 for verifying witnesses for intents. The witness checking function 320 takes as input the intent i, the witness w for the intent i, and the abstract network M. The witness checking function 320 checks that each witness path in the witness w is a valid path in the abstract network M. The witness checking function 320 then performs additional evaluation functions, depending on the intent type of the intent i (e.g., basic segment, protected segment, and chain), for determining whether the witness (w) satisfies the intent i (e.g., whether the witness w matches the intent i).

The witness checking function 320, based on an indication that the intent i is a basis segment, checks that the path defined by witness w satisfies the attribute and region constraints in intent i, obtains M′ from M by reducing the bandwidth on each link by the amount reserved for that link on w, and returns M₁.

The witness checking function 320, based on an indication that the intent i is a protected segment of intents i₀, i₁ with witnesses w₀, w₁, checks that the paths w₀, w₁ are node and port disjoint, computes M₀:=wcheck (i₀, w₀, M), computes M₁:=wcheck (i₁, w₁, M₀), and returns M₁.

The witness checking function 320, based on an indication that the intent i is a chain of intents i₀, . . . , iₙ with witnesses w₀, . . . , wₙ, end-to-end constraints delay D and bandwidth B, and global region constraints, operates as follows. The witness checking function 320 assigns Dₙ:=D. The witness checking function 320, for k from n down to 0, performs the following: (1) if k>0, then check that start point of wₖ is connected to the end point of wₖ₋₁ and (2) let i′ₖ be iₖ with additional constraints (of minimum bandwidth B, maximum delay Dₖ and global region constraints), then compute M:=wcheck(i′ₖ, wₖ, M), and then compute Dₖ₋₁:=Dₖ−maxdelay(wₖ). The witness checking function 320 then returns M.

It is noted that the NOS may produce fresh witnesses for each active intent, not just for the intent which triggers the latest change. This may be done for a number of reasons. First, fresh witnesses may be provided since, as described above, the route selection algorithm may re-route witness paths for earlier intents in order to satisfy a new intent (such that the earlier witness paths may no longer be applicable or valid). Second, fresh witnesses may be provided since, as also described above, it is not expected to be possible to reduce the satisfaction of a set of intents on a network to individual satisfaction of each intent.

It is noted that the witness verification process operates in linear time in the size of the flattened network, the intents, and the witnesses (where, in the case of protected segments, checking disjointness of paths can be done in linear time, on average, using hashing). It will be appreciated that, although primarily presented with respect to embodiments in which the witness verification process fully flattens the entire network before checking the witnesses, in at least some embodiments the witness verification process may only flatten those sections of the network which are traversed by the witness paths.

It is noted that the intent descriptions fit the general form: “there exists a sub-graph H such that φ(H) holds”, where φ(H) is a polynomial-time checkable property. There is a strong similarity to Fagin's characterization of NP in terms of existential second order formulae on graphs. This form may be taken as a general template for formulating other types of intents for which witness checking—i.e., checking whether φ holds for the witness H—can be carried out in polynomial time.

It will be appreciated that, although primarily presented herein with respect to an embodiment (e.g., witness verification pseudocode 300) in which every intent is checked responsive to a triggering event (e.g., receipt of a new intent, a network change in the underlying communication network, or the like), in at least some embodiments only a portion of the intents are checked responsive to a triggering event (e.g., using an incremental witness verification process).

It is noted that checking of every intent responsive to a triggering event is only expected to be required in the worst case and, thus, performing such checking in most cases is expected to lead to unnecessary work. For example, checking of every intent responsive to a triggering event is expected to lead to unnecessary work when the system is operating normally, and, thus, when it should suffice to check the newest intent against the residual capacity network that is created after processing the witnesses of the earlier intents.

It is noted that use and operation of such an incremental witness verification process may be further understood by first considering the following observations. The first observation is that the capacity reduction created by processing a witness may be reversed by increasing capacity along the witness path(s) by the specified amount. The second observation is that the order of checking does not matter (e.g., if witnesses for intents a and b are verified when checked on a network M in that order, there is sufficient capacity for witness paths of both witnesses in M and, thus, the checks made in the reverse order will also succeed).

In at least some embodiments, the incremental witness verification process may operate as follows. The incremental witness verification process maintains a list W, of intent-witness pairs associated with a set of routing decisions, with a corresponding list, M, of residual capacity networks (i.e., M(k) is the residual capacity in the network after processing the witnesses in W(0), . . . , W(k−1)). Let the output of the route selection process be a list of intent-witness pairs, D, showing the intents for which new witnesses have been selected. The incremental witness verification process may then operate as follows.

The first step of the incremental witness verification process is to, for each (i, w′) in D, if there is an entry for intent i, say (i, w), in W at position k, undo the capacity reduction effect of checking witness w by adding back the capacity used by routes in witness w to all residual networks M(j), where j>k. Then, the entry is removed from W and its corresponding entry is removed from M. In other words, the incremental witness verification process puts back the capacity used by the witnesses that have been modified.

The second step of the incremental witness verification process is to add in the effects of any network change that reduces the capacity of a link I by reducing the capacity of link I in each of the M entries, check that none of the remaining witness paths use the link I and, if this is not the case, stop with error. It is noted that it is the responsibility of the route selection process to produce a new witness if the existing one is affected by network changes. This is used to take into account any link capacity changes that have occurred since the last check.

The third step of the incremental witness verification process is to add in the effects of any network change that adds new links or increases link capacity by making the change in each of the M entries. This is used to take into account any link capacity changes that have occurred since the last check. It is noted that it may be required that the route selection process produce a new witness for any witness whose paths include the modified link.

The fourth step of the incremental witness verification process is to let M(*) be the final network in M, check the intent-witness entries in D (starting from M(*)) to verify that the witnesses satisfy the intents (e.g., using the witness checking function 320 of FIG. 3), and append D to the W list and the corresponding intermediate residual networks to the M list. In other words, the incremental witness verification process checks the modified witnesses against the residual network that results from the other steps of the incremental witness verification process.

It is noted that, for the incremental routing intent evaluation process, checking the intents out of arrival order is acceptable due to the observation above on check commutation.

It is further noted that, for the incremental routing intent evaluation process, the normal case is expected to where the one in which there are no network changes and the residual capacity suffices for the latest intent such that the response to the latest intent, i₀, is a single pair, say (i₀, w₀) in D. In this case, the first three steps of the incremental routing intent evaluation process are not needed and the latest intent (i₀, w₀) is evaluated on the last network M (i.e., the incremental routing intent evaluation process essentially becomes the witness verification pseudocode 300 presented with respect to FIG. 3).

In at least some embodiments, the incremental witness verification process may operate as follows. The incremental witness verification process maintains a list W, of intent-witness pairs associated with a set of routing decisions; however, rather than maintaining a list of corresponding residual capacity networks as discussed above, maintains only the latest network, M, which is obtained by checking the list W of intent-witness pairs on the initial network, M₀. Let the output of the route selection process be a list of intent-witness pairs, D, showing the intents for which new witness paths have been selected. The incremental witness verification process may then operate as follows.

The first step of the incremental witness verification process is to, for each (i, w′) in D, if there is an entry for intent i, say (i, w), in W, undo the capacity reduction effect of checking witness w by adding back the capacity used by routes in witness w to M. Then, the entry is removed from W. In other words, the incremental witness verification process puts back the capacity used by the witnesses that have been modified.

The second step of the incremental witness verification process is to add in the effects of any network change that reduces the capacity of a link I by reducing the capacity of link I in M, check that none of the remaining witness paths in W use the link I and, if this is not the case, stop with error. It is noted that it is the responsibility of the route selection process to produce a new witness if the existing one is affected by network changes. This is used to take into account any link capacity changes that have occurred since the last check.

The third step of the incremental witness verification process is to add in the effects of any network change that adds new links or increases link capacity by making the addition in M. This is used to take into account any link capacity changes that have occurred since the last check. It is noted that it may be required that the route selection process produce a new witness for any witness whose paths include the modified link.

The fourth step of the incremental witness verification process is to let M′ be the network after the above-described network changes (of the second and third steps) are made to M, check the intent-witness entries in D (starting from M′) to verify that the witnesses satisfy the intents (e.g., using the witness checking function 320 of FIG. 3), and append D to the W list. In other words, the incremental witness verification process checks the modified witnesses against the residual network that results from the other steps of the incremental witness verification process.

It is noted that the stored network for the next stage is the network M″ that is obtained after checking the new witnesses on M′.

It is noted that, for the incremental witness verification process, checking the witnesses of intents out of arrival order is acceptable due to the observation above on check commutation.

It is further noted that, for the incremental witness verification process, the normal case is expected to be the one in which there are no network changes and the residual capacity suffices for the latest intent such that the response to the latest intent, i₀, is a single pair, say (i₀, w₀) in D. In this case, the first three steps of the incremental witness verification process are not needed and the latest intent (i₀, w₀) is evaluated on the last network M (i.e., the incremental witness verification process essentially becomes the witness verification pseudocode 300 presented with respect to FIG. 3).

It is noted that, while primarily presented herein with respect to embodiments in which the entire network may be used as an input for use in performing witness verification processing (with the entire network or relevant portions thereof being flattened, as indicated above), in at least some embodiments network abstraction may be applied to the network in order to obtain an abstracted (and, thus, simpler) network which may be used as the input for use in performing witness verification processing.

In general, real networks have an immense amount of detail, not all of which is needed for route selection. Additionally, the route optimization problem is usually quite difficult, typically NP-hard, so practical algorithms generally operate not on the entire network but, rather, on abstractions of the entire network, which collapse sub-networks or hide other details. However, many such abstractions that are used may result in loss of information which may be used to determine feasibility of routes. As such, in order to perform witness verification processing, network abstraction is performed in a way that preserves the feasibility of routes (since any intent satisfied for an abstraction of a network should be satisfiable on the actual network itself).

For an NOS, given an intent (or a set of intents), usually only a small part of the network needs to be examined to select routes and generate the corresponding witness(es) and, thus, it is usually unnecessary to overwhelm the route selection algorithm with a detailed description of the whole network. For example, when an intent that requests a connection between two offices inside New York City is received, it would be superfluous to take into consideration the information about nationwide networks, e.g. networks in San Francisco; conversely, when setting up a nationwide route, it would be tedious to examine all of the detailed information about networks in a single city. Moreover, the complexity of route selection increases rapidly with network size. For these reasons, it is desirable to shrink a network by collapsing sub-networks or by hiding details of the network implementation, so that the NOS can work as effectively as possible. It is important, however, that the routes discovered at an abstract level are realizable as routes at the concrete level; otherwise, there is no benefit to perform the abstraction.

In network abstraction, the general idea is to get an abstract network by collapsing a specified sub-network of a concrete real network into a single node. This may be provided by defining a notion of refinement from the concrete to the abstract level, and showing that this preserves the realizability of routes. For the formal development, however, it is useful to first analyze the case where a single abstract node is mapped to a concrete graph and then to extend this to a relationship between the whole abstract network and corresponding concrete network.

As noted above, network abstraction may be further understood by first considering abstraction and refinement with single nodes.

Consider the case where a graph G is abstracted to a new primitive graph H whose external ports are isomorphic to the external ports of G. Here, the key question is to define a relation between paths and capabilities in G with those in H, so that routes in H can be realized as routes in G. As H is primitive, routes in H are links between ports; routes in G are paths through the graph G.

A refinement map R from H to G is a function such that the following properties hold: (a) each link (n, p, q, i) in H (i.e., the i′th link between port p and q of node n) is mapped by R to a path π between ports p and q in G, where the capability of π in G is better than the capability of link (n, p, q, i) in H, (b) the set of paths {R(n, p, q, i)|(n, p, q, i) is a link in H} are node and port disjoint in G, and (c) node n and all nodes of G have the same abstract region labels.

The refinement map constrains the capabilities, not the weights of the corresponding paths. Hence, it is possible that a different algorithm can be applied to G to arrange the weights.

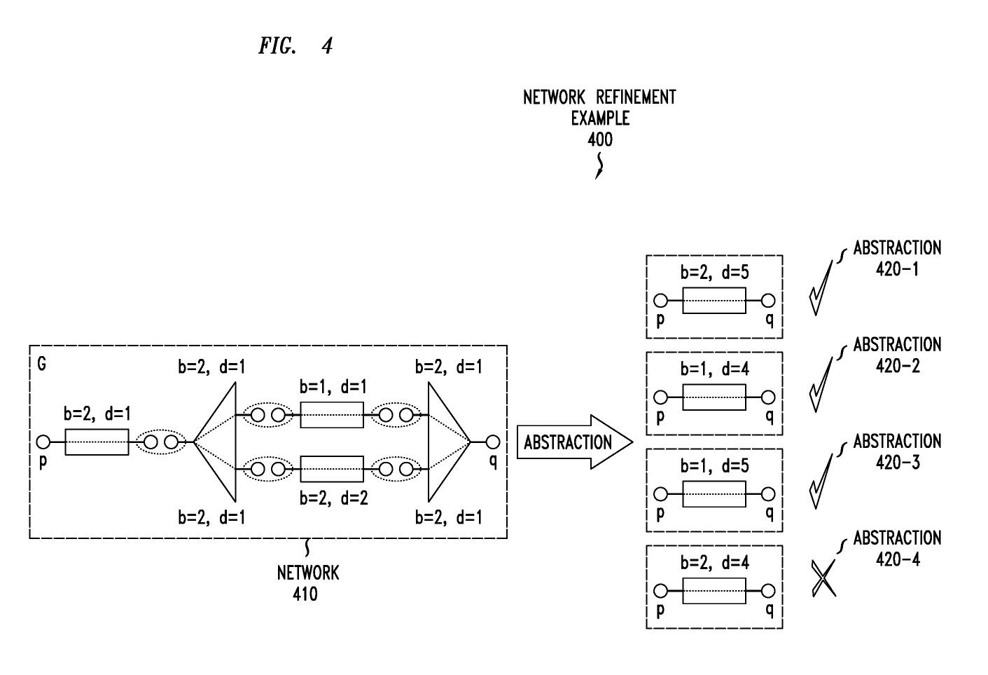

FIG. 4 depicts an example of network refinement to abstract a communication network to form an abstracted network for use in validating routing decisions for the communication network.

The network refinement example 400 includes a network 410 and four potential abstractions 420-1-420-4 (abstractions 420) of the network 410.

In network refinement example 400, for purposes of clarity, the formal notion of graph references are not used, but, rather, the details are shown directly. For example, ports are represented as circles, channels are represented as long rectangles, and multiplexers/demultiplexers are represented as triangles. Similarly, for example, a dashed line between two ports is a link, and a dashed ellipse with two ports inside shows that those ports are part of a connection (e.g., in G, the right port of left channel is connected to the left port of demultiplexer). The capability of the single link for each pair of ports is shown near the host node (e.g., in G, “b=2, d=1” above the left triangle means that, for the upper link inside the demultiplexer, the bandwidth is 2 and delay is 1).

In network refinement example 400, the network 410 is represented as a graph G. Between ports p and q in G, there are two non-disjoint paths: (1) one path goes through the upper channel in the middle, and has capability “b=1, d=4” and (2) the other path goes through the lower channel in the middle, and has capability “b=2, d=5”.

In network refinement example 400, the abstractions are labeled as H. There are multiple options for defining the capability of the abstract link in H. The four possible abstractions 420 are shown. The abstractions 420-1, 420-2, and 420-3 are correct (i.e. there is a refinement connecting H to G). The abstractions 420-1 and 420-2 represent the capabilities of the paths in G described above. The abstraction 420-3 is a manufactured capability representing the worst of the two paths. The abstraction 420-4 is incorrect, however, as there is no path in G from p to q with capability better than “b=2, d=4”.

Consider the following Lemma (denoted herein as Lemma 1). Lemma 1 states the following: Let primitive graph H be an abstraction of graph G. Any intent I that can be satisfied in H can also be satisfied in G. A proof of Lemma 1 follows.

For the proof of Lemma 1, let R be the refinement map from H to G. The three types of intents will be considered below.

(1) Basic Segment: The intent I is a basic segment between port p and q: H is a primitive graph that consists of only one node, say n, thus the witness in H must be a path from p to q consisting of a single link. Let such a witness be p, n, i, w, q, where w=(b, d) must be worse than the capability of link (n, p, q, i), and w satisfies the attribute constraints of I. From the refinement relation R, there is a corresponding path π=R(n, p, q, i) in graph G, with capability better than the capability of (n, p, q, i). By transitivity, the path capability is better than w and, thus, it satisfies bandwidth and delay constraints. The satisfaction of abstract region constraints is preserved by part (c) of refinement (which states that node n and all nodes of G have the same abstract region labels). Let each link along the path be allocated its capability; then the allocated path satisfies intent I in G.

(2) Protected Segment: The intent I is a protected segment between port p and q: H is a primitive graph that consists of only one node, say n, thus the witness in H must be two paths each of which consists of a single link. By the same argument in (1) for the basic segment, two paths which satisfy the two basic segments in I can be found in G. From the condition (b) of refinement (which states that the set of paths {R(n, p, q, i)|(n, p, q, i) is a link in H} are node and port disjoint in G), those two paths must be node and port disjoint. Thus, those two paths together forms a witness for I in G.

(3) Chain: The intent I is a chain: this cannot happen, because a chain cannot be satisfied by a primitive graph.

As indicated above, the joint satisfaction of a set of intents does not necessarily follow from showing that each intent can be individually satisfied. In the following, it is shown that refinement also preserves joint realizability.

Consider the following Lemma (denoted herein as Lemma 2). Lemma 2 states the following: Let primitive graph H be an abstraction of graph G. Every set of intents IS that can be jointly satisfied in H can also be jointly satisfied in G. A proof of Lemma 2 follows.

For the proof of Lemma 2, first consider Lemma 1. By Lemma 1, each individual intent in IS can be satisfied in G. To be precise, for every individual intent in IS, if it can be satisfied by a witness path(s) in H, then there exists a corresponding witness path(s) of the same allocated weight in G. The only potential problem comes from oversubscribing the bandwidth on any common links of the witnesses; however, as shown below, this cannot be the case.

Suppose that a link (n′, p′, q′, i′) in G is shared by a set of witness paths {πⱼ}. Let the corresponding witness paths in H be {σⱼ|R(σⱼ)=πⱼ}; as H is primitive, this is a collection of links. By the condition (b) of refinement (which, again, states that the set of paths {R(n, p, q, i)|(n, p, q, i) is a link in H} are node and port disjoint in G), all the paths in {πj} must be the same but for their allocated weights, and all the paths in {σⱼ} use the same link, say (n, p, q, i). From condition (a) of refinement (which states each link (n, p, q, i) in H (i.e., the i′th link between port p and q of node n) is mapped by R to a path π between ports p and q in G, where the capability of π in G is better than the capability of link (n, p, q, i) in H), the capability of πⱼ is better than the capability of σⱼ, which is cap(n, p, q, i). Hence, the capability of every link (including (n′, p′, q′, i′)) along the path πⱼ is better than cap(n, p, q, i), and the bandwidth of (n′, p′, q′, i′) must be larger or equal to the bandwidth of (n, p, q, i). Since IS can be jointly satisfied in H, the bandwidth of link (n, p, q, i) must be larger than or equal to the sum of bandwidth entries in the allocated weights of {σⱼ}. As indicated in the proof of Lemma 1, the allocated weight of πⱼ is equal to that of σⱼ and, hence, the bandwidth of link (n′, p′, q′, i′) is larger than or equal to the sum of bandwidth entries allocated by {πⱼ} on (n′, p′, q′, i′). This shows that bandwidth is not over-allocated in the witness paths for G; hence, IS can be jointly satisfied in G.

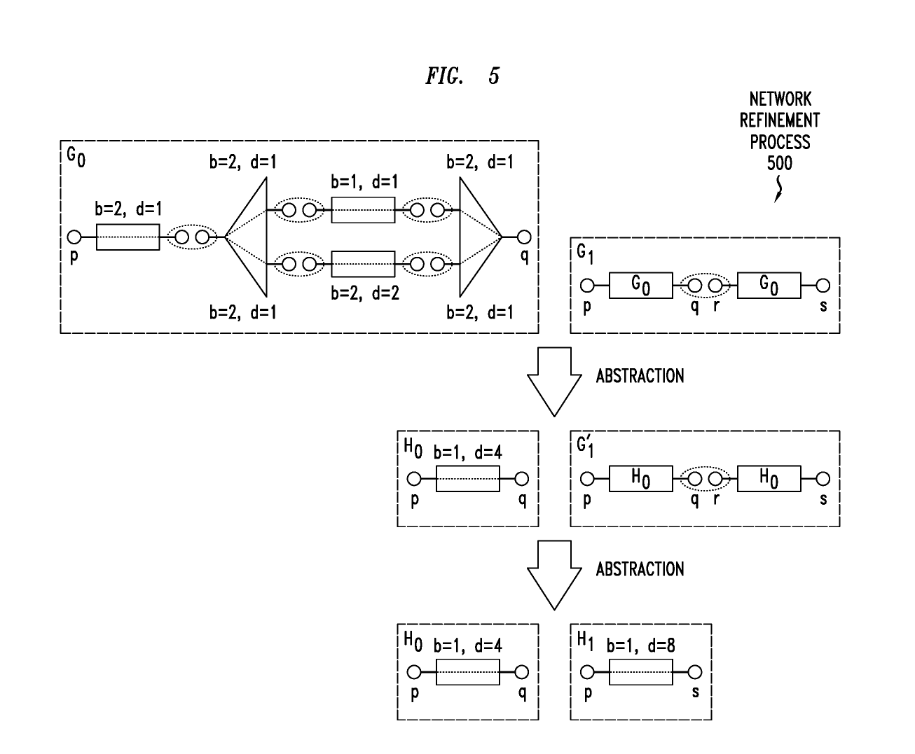

As noted above, network abstraction may be further understood by considering the abstraction and refinement with single nodes that is discussed above. In the discussion above regarding abstraction and refinement for single nodes, it was shown that the realizability of routes is preserved if a graph is collapsed to a single primitive graph. This result may be extended to a portion of a network or even to an entire network. Here, network A is deemed to be an abstraction of network C=(G0, G1, . . . , Gn) if there is a chosen subset GS of {G₀, G₁, . . . , Gn}, and A is gained from C by replacing each graph Gᵢ in Gs with a primitive graph Hᵢ such that there is a refinement Rᵢ from primitive graph Hᵢ to graph Gᵢ. The size of abstraction is defined as the cardinality of GS. This may be further understood by way of reference to the example of FIG. 5.

FIG. 5 depicts an example process for network refinement to abstract a communication network to form an abstracted network for use in validating routing decisions for the communication network.

In the network refinement process 500, the concrete network C has two graphs (G0, G1), where G0 comes from the network refinement example 400 of FIGS. 4 and G1 contains two connected nodes referring to G0.

In the network refinement process 500, a first abstraction is performed based on the concrete network C. Namely, from the discussion above regarding abstraction and refinement with single nodes, it is known that there exists a refinement relation from the primitive graph H₀ to G₀ and, thus, by replacing G₀ with H₀, an abstract network (H₀, G′₁) is obtained where G′₁=G₁[G₀:=H₀] (the brackets indicate substitution of references to G₀ by references to H₀). The size of this abstraction is 1.

In the network refinement process 500, a first abstraction is performed based on the result of the first abstraction discussed above. Namely, another abstraction of size 1 can be performed on H₀, G′₁ by replacing it with the primitive graph H₁, since there is an abstraction refinement from H₁ to G′₁. Now, an ultimately abstract network (H₀, H₁) is obtained, and no more abstraction can be applied.

In the network refinement process 500, it is not difficult to find that, for any set of intents that can be jointly satisfied in the abstract network (H₀, H₁), it can be jointly satisfied in the original network (G₀, G₁) as well.

Consider the following Lemma (denoted herein as Lemma 3). Lemma 3 states the following: Let network A be an abstraction of network C by an abstraction of size 1. Every set of intents IS that can be jointly satisfied in A can also be jointly satisfied in C. A proof of Lemma 3 follows.

For the proof of Lemma 3, suppose that C=(G₀, G₁, . . . , Gn), and A is gained from C by replacing one chosen graph Gc with a primitive graph Hc such that there is a refinement from Hc to Gc (i.e., A=(G₀, G₁, . . . , G_{c-1}, H_{c}, G_{c}+1[G_{c}:=H_{c}], . . . , Gₙ[G_{c}:=H_{c}])). For clarity, further suppose that network A is flattened, so that it is a graph in which every node refers only to a primitive graph.

For any intent I, if the intent I can be satisfied in A by a witness that does not pass through any node that refers to graph H_{c}, it is clear that the same witness can be used in C to satisfy I. Thus, here, there is only a need to discuss the intents IS′whose witnesses in A pass through at least one node whose reference is graph H_{c}.

Let the set of witness paths in A for IS′ be {πⱼ}. Each witness path πⱼ is of form (p′₀,n₀,l₀,w₀,p₁),(p′₁,n₁,l₁,w₁,p₂), . . . (P′ₖ₋₁,nₖ₋₁,lₖ₋₁,wₖ₋₁,Pₖ). Each witness path πⱼ can be divided into k separate paths {π′ⱼ=P′ₖ₋₁,nᵢ₋₁,lᵢ₋₁,wᵢ₋₁,pᵢ|1≤i≤k}, each of which contains only one link from port P′ᵢ₋₁ of node nᵢ₋₁ to port pᵢ of node nᵢ₋₁. Accordingly, k new intents can be created: I′ⱼ is a basic segment from port P′ᵢ₋₁ of node nᵢ₋₁ to port pᵢ of the same node nᵢ₋₁ with attribute constraints the same as wᵢ₋₁.

By definition, each new intent Iⱼⁱ can be satisfied by the corresponding path πⱼⁱ in A. Also, it is clear that, no matter in A or in C, if the set of newly created intents {Iⱼⁱ} can be jointly satisfied, then the original intents can be also jointly satisfied. IT may be proven that {Iⱼⁱ} can be jointly satisfied in C. For each Iᵢ^{j}, if the corresponding node nᵢ₋₁ does not refer to H_{c}, then πⱼⁱ is still a valid path in C and satisfies πⱼⁱ; otherwise, πⱼⁱ is a basic segment between two ports of primitive graph H_{c}, and it can be satisfied by πⱼⁱ in H_{c}, then, by Lemma 2, πⱼⁱ can be satisfied in G_{c} as well. Therefore, the set of newly created intents can be jointly satisfied in C; hence, so does the set of original intents.

Consider the following Theorem (denoted herein as Theorem 1). Theorem 1 states the following: Let network A be an abstraction of network C. Every set of intents IS that can be jointly satisfied in A can also be jointly satisfied in C. A proof of Theorem 1 follows.

For the proof Theorem 1, suppose that the size of abstraction from C to A is k. Then, generate a series of networks N₁=A, N₂, N₃, . . . , Nₖ=C such that Nᵢ₊₁ is a refinement of Nᵢ₊₁ with an abstraction of size 1. By Lemma 3, for any set of intents that can be jointly satisfied in N₁, it can also be jointly satisfied in Nᵢ₊₁. By induction, it follows that any set of intents IS that is jointly satisfied in A is also jointly satisfied in C.

It is noted that realizability of intents can be preserved across multiple abstract levels, i.e. if a network A is an abstraction of network B while network B is an abstraction of network C, then for any set of intents that can be jointly satisfied in A, it can also jointly satisfied in C. A simple example of this has illustrated in FIG. 5.

It will be appreciated that, although primarily presented herein with respect to use of embodiments of the routing intent validation capability to validate specific types of routing intents (namely, end-to-end path-related intents such as paths, protected paths, and chains of paths), embodiments of the routing intent validation capability may be used to validate various other types of routing intents (e.g., broadcast trees, multicast trees, virtual local area networks (VLANs), VLANs with backup paths, or the like). In general, a routing intent may be any graph type which has an efficiently-checkable witness. For example, witnessing may be used to handle any graph type T that may be described by “a graph H is in class T if, and only if, there exist subgraphs G₀, . . . , Gₖ of H for which property φ(G₀, . . . , Gₖ) holds, and φ is efficiently checkable” and, here, the witness is given by producing the subgraphs G₀, . . . , Gₖ and the check evaluates property φ on those graphs.

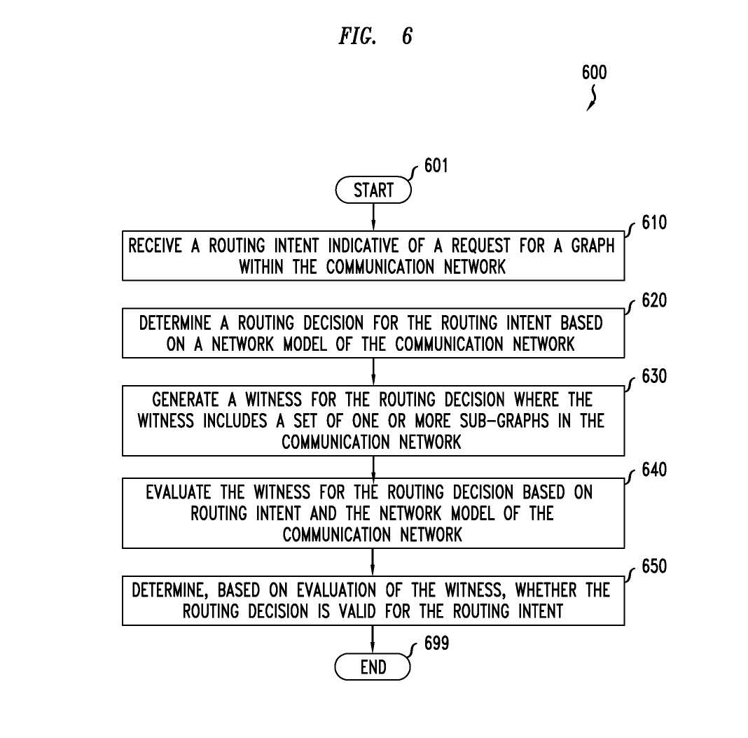

FIG. 6 depicts an example method for supporting validation of routing decisions for a communication network. It will be appreciated that, although the functions of the method 600 of FIG. 6 are primarily presented herein as being performed serially, at least a portion of the functions of the method 600 of FIG. 6 may be performed contemporaneously or in a different order than as presented in FIG. 6.

At block 601, method 600 starts.

At block 610, a routing intent, indicative of a request for a graph within the communication network, is received.

At block 620, a routing decision for the routing intent is determined based on a network model of the communication network.

At block 630, a witness for the routing decision is generated where the witness for the routing decision includes a set of one or more sub-graphs in the communication network.

At block 640, the witness for the routing decision is evaluated based on the routing intent and based on the network model of the communication network.

At block 650, a determination is made, based on evaluation of the witness for the routing decision, as to whether the routing decision is valid for the routing intent.

At block 699, method 600 ends.

It will be appreciated that various embodiments of the routing decision validation capability presented herein may provide various advantages or potential advantages. For example, various embodiment of the routing decision validation capability may be configured to support various network management functions provided using increased level of abstraction and unification (thereby enabling benefits such as supporting more sophisticated algorithms for route selection, failure recovery, and the like) while minimizing or even eliminating the danger that software errors and malicious code may cause significant disruption in the underlying networks. For example, various embodiment of the routing decision validation capability may be configured to support on-the-fly route calculation and installation with support for route validation in a manner that may reduce or even eliminate implementation errors that may produce wrong routes that could cause significant network disruption in the CN 110. For example, various embodiment of the routing decision validation capability may be configured to obviate the need for use of a formally verified OS, for which runtime checks are unnecessary, since constructing such a formally verified OS is typically an enormously difficult task. It will be appreciated that various embodiments of the routing intent validation capability may provide various other advantages or potential advantages.

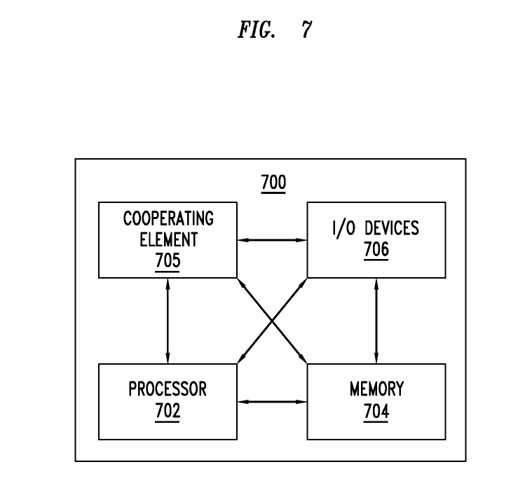

FIG. 7 depicts a high-level block diagram of a computer suitable for use in performing various functions described herein.

The computer 700 includes a processor 702 (e.g., a central processing unit (CPU), a processor having a set of processor cores, or the like) and a memory 704 (e.g., a random access memory (RAM), a read only memory (ROM), or the like). The processor 702 and the memory 704 are communicatively connected.

The computer 700 also may include a cooperating element 705. The cooperating element 705 may be a hardware device. The cooperating element 705 may be a process that can be loaded into the memory 704 and executed by the processor 702 to implement functions as discussed herein (in which case, for example, the cooperating element 705 (including associated data structures) can be stored on a non-transitory computer-readable storage medium, such as a storage device or other storage element (e.g., a magnetic drive, an optical drive, or the like)).

The computer 700 also may include one or more input/output devices 706. The input/output devices 706 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices (e.g., a tape drive, a floppy drive, a hard disk drive, a compact disk drive, or the like), or the like, as well as various combinations thereof.

It will be appreciated that computer 700 of FIG. 7 may represent a general architecture and functionality suitable for implementing functional elements described herein, portions of functional elements described herein, or the like, as well as various combinations thereof. For example, computer 700 may provide a general architecture and functionality that is suitable for implementing one or more of an element of CN 110, NOS 120, a portion of NOS 120, network model 121, route selection element 122, witness-based checking element 123, a route installation element 124, or the like.

It will be appreciated that the functions depicted and described herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits (ASIC), and/or any other hardware equivalents).

It will be appreciated that at least some of the functions discussed herein as software methods may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored in fixed or removable media (e.g., non-transitory computer-readable media), transmitted via a data stream in a broadcast or other signal bearing medium, and/or stored within a memory within a computing device operating according to the instructions.

It will be appreciated that the term “or” as used herein refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
a processor and a memory communicatively connected to the processor, the processor configured to:
receive a routing intent indicative of a request for a graph within a communication network;
determine a routing decision for the routing intent based on a network model of the communication network;
generate a witness for the routing decision, wherein the witness comprises a set of one or more sub-graphs in the communication network;
evaluate the witness for the routing decision based on the routing intent and based on the network model of the communication network; and
determine, based on evaluation of the witness for the routing decision, whether the routing decision is valid for the routing intent.

2. The apparatus of claim 1, wherein the routing intent comprises a new routing intent that has not been satisfied within the communication network, an existing routing intent that has not been satisfied within the communication network, or an existing routing intent that is currently satisfied within the communication network.

3. The apparatus of claim 1, wherein the routing intent is received based on a request for the routing intent or based on an indication of a network change in the communication network.

4. The apparatus of claim 1, wherein the routing intent comprises a request for a graph, a request for a basic segment within the communication network, a request for a pair of protected segments within the communication network, a request for a chain of segments within the communication network, a request for a multicast tree within the communication network, a request for a broadcast tree within the communication network, or a request for a virtual local area network (VLAN) within the communication network.

5. The apparatus of claim 1, wherein the routing decision comprises a description of a set of one or more sub-graphs in the communication network.

6. The apparatus of claim 5, wherein, to evaluate the witness for the routing decision, the processor is configured to:
determine, based on the network model, whether the witness for the routing decision satisfies the routing intent.

7. The apparatus of claim 6, wherein, to determine whether the witness for the routing decision satisfies the routing intent, the processor is configured to:
determine, for each of the one or more sub-graphs of the witness based on the routing intent and the network model, whether the respective sub-graph satisfies the routing intent.

8. The apparatus of claim 1, wherein the routing decision comprises a description of a set of route changes in the communication network.

9. The apparatus of claim 8, wherein, to evaluate the witness for the routing decision, the processor is configured to:
determine, based on the network model, whether the witness for the routing decision satisfies the routing intent; and
determine whether the routing decision is consistent with the witness for the routing decision.

10. The apparatus of claim 9, wherein, to determine whether the witness for the routing decision satisfies the routing intent, the processor is configured to:
determine, for each of the one or more sub-graphs of the witness based on the routing intent and the network model, whether the respective sub-graph satisfies the routing intent.

11. The apparatus of claim 9, wherein, to determine whether the routing decision is consistent with the witness for the routing decision, the processor is configured to:
determine, based on the network model, whether the description of the set of route changes of the routing decision is consistent with the set of one or more sub-graphs of the witness for the routing decision.

12. The apparatus of claim 1, wherein, to evaluate the witness for the routing decision, the processor is configured to:
determine, for each of the one or more sub-graphs of the witness based on the network model, whether the respective sub-graph is a valid sub-graph within the communication network; and
determine, for each of the one or more sub-graphs of the witness based on the routing intent, whether the respective sub-graph satisfies the routing intent.

13. The apparatus of claim 1, wherein, to evaluate the witness for the routing decision, the processor is configured to:
determine whether the witness for the routing decision satisfies the routing intent.

14. The apparatus of claim 13, wherein the routing intent has a property associated therewith, wherein, to determine whether the witness for the routing decision satisfies the routing intent, the processor is configured to:
determine, for each of the one or more sub-graphs of the witness based on the network model of the communication network, whether the respective sub-graph satisfies the property of the routing intent.

15. The apparatus of claim 14, wherein the property of the routing intent is configured to describe:
for each of the one or more sub-graphs of the witness, a respective shape of the respective sub-graph of the witness; and
a manner in which the one or more sub-graphs of the witness are related.

16. The apparatus of claim 15, wherein, for at least one of the one or more sub-graphs of the witness, the respective shape of the respective sub-graph of the witness is a segment, a chain, a cycle, or a tree.

17. The apparatus of claim 1, wherein a manner in which the witness for routing decision is evaluated depends on an intent type of the routing intent.

18. The apparatus of claim 17, wherein the routing intent comprises a request for a basic segment within the communication network, wherein the witness comprises a single path, wherein, to evaluate the witness for the routing decision, the processor is configured to:
determine, for the single path of the witness, whether the single path satisfies region and attribute constraints of the routing intent.

19. The apparatus of claim 17, wherein the routing intent comprises a request for a protected segment within the communication network, wherein the witness comprises a pair of paths, wherein, to evaluate the witness for the routing decision, the processor is configured to:
determine, for the pair of paths of the witness, whether the paths are disjoint.

20. The apparatus of claim 17, wherein the routing intent comprises a request for a chain of segments within the communication network, wherein the witness comprises a chain of paths, wherein, to evaluate the witness for the routing decision, the processor is configured to:
determine, for the chain of paths of the witness, whether the chain of paths satisfies an end-to-end constraint.

21. The apparatus of claim 20, wherein, to determine, for the chain of paths of the witness, whether the chain of paths satisfies an end-to-end constraint, the processor is configured to:
strengthen a delay requirement on a remaining path of the chain of paths by subtracting a maximum delay incurred on a current path of the chain of paths.

22. The apparatus of claim 20, wherein the end-to-end constraint comprises a delay constraint, a bandwidth constraint, or a global region constraint.

23. The apparatus of claim 1, wherein, to evaluate the witness for the routing decision, the processor is configured to:
update a map of residual capacity in the communication network by removing bandwidth reserved for the one or more sub-graphs of the witness of the routing decision.

24. The apparatus of claim 1, wherein the processor is configured to:
initiate installation of the routing decision within the communication network for the routing intent based on a determination that the routing decision is valid for the routing intent.

25. The apparatus of claim 1, wherein the processor is configured to:
prevent installation of the routing decision within the communication network for the routing intent based on a determination that the routing decision is not valid for the routing intent.

26. The apparatus of claim 1, wherein the processor is configured to:
update the network model based on an indication of a network event associated with the communication network.

27. The apparatus of claim 1, wherein the processor is configured to:
receive a new witness for the routing decision, the new witness based on a network change in the communication network;
evaluate the new witness for the routing decision based on the routing intent and based on the network model of the communication network; and
determine, based on evaluation of the new witness for the routing decision, whether the routing decision is valid for the routing intent.

28. A method, comprising:
receiving, by a processor, a routing intent indicative of a request for a graph within a communication network;
determining, by the processor, a routing decision for the routing intent based on a network model of the communication network;
generating, by the processor, a witness for the routing decision, wherein the witness comprises a set of one or more sub-graphs in the communication network;
evaluating, by the processor, the witness for the routing decision based on the routing intent and based on the network model of the communication network; and
determining, by the processor based on evaluation of the witness for the routing decision, whether the routing decision is valid for the routing intent.

29. An apparatus, comprising:
a processor and a memory communicatively connected to the processor, the processor configured to:
receive a set of intent-witness pairs indicative of a set of routing intents, having respective witnesses associated therewith, associated with respective routing decisions validated for a network based on a network model of the communication network;
receive, based on a route selection process, a set of modified intent-witness pairs comprising ones of the intent-witness pairs for which the respective witness of the respective routing intent has changed to a respective new witness;
update capacity information of the network model, based on the set of intent-witness pairs and the set of modified intent-witness pairs, to provide thereby an updated network model for the communication network; and
verify the routing intents of the set of modified intent-witness pairs based on evaluation of the respective new witnesses of the respective routing intents in the set of modified intent-witness pairs based on the updated network model for the communication network.
